(19) United States
(12) Patent Application Publication
(10) Pub. No.: US 2002/0006115 A1
(43) Pub. Date: Jan. 17, 2002

(54) Non-deterministic software delay estimation method and system for packet based data network systems

(76) Inventors: Kaynam Hedayat, Chestnut Hill, MA (US); Laco Scott Harvell, Brookline, NH (US); Sadredin Tavana, Sudbury, MA (US); Steven A. DesRochers, Londonderry, NH (US)

Correspondence Address: Mark G. Lappin, P.C., McDERMOTT, WILL & EMERY, 28 State Street, Boston, MA, 02109, US

(21) Appl. No.: 09/860,296

(22) Filed: May 18, 2001

Related U.S. Application Data
(60) Provisional application No. 60/264,463, filed on Jan. 26, 2001.
(60) Provisional application No. 60/205,280, filed on May 18, 2000.

(51) Int. Cl. H04L 12/26; G01R 31/08

(52) U.S. Cl. 370/252; 370/465

(57) ABSTRACT

A method of characterizing a propagation delay of a data element propagating from a software source to a physical medium destination includes associating, in software, a first time code with the data element when the software source dispatches the data element to the physical medium destination. The method further includes associating, via a time-stamping circuit, a second time code with the data element when the data element reaches the physical medium destination. The method also includes subtracting the first time code from the second time code so as to calculate the propagation delay. In a similar manner, the method may also be used to characterize the propagation delay of the data element in the reverse direction, i.e., from the physical medium to the software source.

### CROSS-REFERENCE TO RELATED APPLICATIONS

This application is related to the following U.S. applications, of common assignee, from which priority is claimed, and the contents of which are incorporated herein in their entirety by reference:

“Non-Deterministic Software Delay Estimation Method And System For Packet Based Data Network Systems,” U.S. Provisional Patent Application Serial No. 60/264,463; and,

“System For And Method Of Measuring And Reporting Quality And Performance Metrics Associated With Network-Based Services,” U.S. Provisional Patent Application Serial No. 60/205,280.

This application is related to the following U.S. applications, of common assignee:

“IP Packet Identification Method and System for TCP Connection and UDP Stream,” U.S. patent application Ser. No. ______;

“Method And System For Transmit Time Stamp Insertion In A Hardware Time Stamp System For Packetized Data Networks,” U.S. patent application Ser. No. ______;

“Hardware Time Stamping And Registration Of Packetized Data Method And System” U.S. patent application Ser. No. ______;

### STATEMENT REGARDING FEDERALLY SPONSORED RESEARCH

Not Applicable

### REFERENCE TO MICROFICHE APPENDIX

Not Applicable

### BACKGROUND OF THE INVENTION

The present invention relates to packetized data networks, and more particularly, to characterizing the non-deterministic software delays incurred by a packet through a network station as the packet passes to or from the physical network media.

In order to evaluate the functionality and efficiency of a packetized data network, network software applications often monitor many aspects of packet traffic on the network. For example, in order to determine packet propagation delay (also referred to herein as “transit delay,” “transit time” or “propagation time”) from one point on the network to another, a network software application can time-tag (also referred to herein as “time-stamp”) individual packets as they are transmitted or received, and use the time-stamp information to determine propagation time. As used herein, the term “time-tag” or “time-stamp” means to sample a chronometer (or other reference time code source) when the packet is at a particular location in the network, then associate the sampled time code with the packet. Some prior art systems time-stamp the packets that are used in a “ping test” to determine packet propagation delay on a network. A ping test uses echo request packets and echo response packets to create a loop-back test between two stations on a network. FIG. 1 illustrates how a prior art system 10 uses a ping test to determine packet propagation delay. The system 10 includes a first station 12 and a second station 14 that communicate via a network medium 16. Each station includes test application software 18, several layers of intermediate software 20, a medium access controller (MAC) 22, and a physical medium interface (PHY) 24 (e.g., an Ethernet interface). The test application software 18:1 in the first station 12 generates and time-stamps an echo request packet. The application software 18:1 immediately sends the packet through the layers of intermediate software 20:1 (also referred to herein as the “software stack”), the MAC 22:1 and the PHY 24:1, and out to the second station 14 via the network medium 16. When the echo request packet reaches the second station 14, the packet passes through the PHY 24:2, the MAC 22:2, the software stack 20:2, and is received by the application software 18:2. The application software 18:2 compiles an echo response packet and sends the response packet back through the stack 20:2, the MAC 22:2, the PHY 24:2 and out to the first station 12 via the network medium 16. When the echo response packet reaches the first station 12, the packet passes through the PHY 14:1, the MAC 22:1, the stack 20:1 and is received and time-stamped by the application software 18:1. The application software 18:1 calculates the difference between the time-stamp of the received echo request packet and the time-stamp of the transmitted echo response packet to determine the round-trip propagation delay of the packet.

One disadvantage of such prior art systems is that since the packet time-stamping occurs at the application software 18:1, the propagation times through the software stacks 20:1 and 20:2 are included in the round trip time that the application software 18:1 calculates. The propagation times through the software stacks 20:1 and 20:2 are subject to non-deterministic delays induced by operating systems and software processes. The delays are non-deterministic because the operating systems and software processes are typically multitasking, and thus dependent on instantaneous loading from various external factors. Further, the chronometer that a typical prior art system uses is often software-based, and therefore vulnerable to the same non-deterministic effects that influence the software stacks. Since the delays induced via such prior art time stamping schemes are non-deterministic, accurate arrival and network infrastructure transit times are not possible to predict. An accurate arrival time for packets is of particular interest in communications systems for applications that are delay-bounded, such as voice and video. This is especially true when the inaccuracy in marking transmit and arrival times is greater than the jitter and delay resolution required by real time application.

Many prior art systems ignore the propagation times though the software stacks, and the software time-tag (i.e., the time the software associates to a packet) is deemed close enough to the true time that the packet is transferred to or received from the network medium, for the purposes of measuring the packet propagation time. In such prior art systems, the resulting errors in the timing data due to the non-deterministic propagation times through the software stacks are simply accepted, and the application that uses the timing data builds in margins to account for the error.

A disadvantage with associating time-stamps in software is the inclusion of non-deterministic system delays in the measurements. The measurements include the propagation times through the system's software stacks that lie below the layer that the time-tag was performed. When the system goal is to measure timing on the wire (i.e., timing with respect to the point where the packet is transferred to or received from the network), including the non-deterministic delays through the system's software skews the result.

It is an object of the present invention to substantially overcome the above-identified disadvantages and drawbacks of the prior art.

### SUMMARY OF THE INVENTION

The present invention estimates the value of time-stamp on the “wire” (i.e., the physical transmission medium) for outgoing and incoming packets, as a function of the time-stamp performed in software, by benchmarking the non-deterministic transition time through the system's network stack layers and hardware queuing processes. The invention determines the benchmark, and modifies the software time-stamp by the benchmark value to provide an estimate of the true time-stamp on the wire.

The benchmark process is possible on a system that includes a hardware time-stamp capability. Hardware time-stamp is a time code associated with an incoming/outgoing packet on the wire prior to entering/after leaving the software layer or queuing process. Related U.S. application Ser. No. ______ (attorney docket number BRXL-136) provides one example of an apparatus for creating such a hardware time-stamp. For a system with a hardware time-stamp capability, one method to achieve accuracy is to observe packets on the wire, associate a timestamp to each one, then pass the time-stamp information to the application level software for each packet. Doing so eliminates the software layer timing altogether, and with it the need to benchmark. However, the implementation of this approach adds complexity to the application level software, and requires additional memory to store the timestamps for each packet. The benchmarking process described herein provides a way to increase the accuracy of a software time-stamp without incurring the aforementioned added complexity.

One embodiment of the invention accomplishes the benchmarking by periodically transmitting packets of different size and type out to the network physical medium (i.e., the wire). The packets generated by the software source are looped back into the system through special hardware that detects the test packets. Before transmitting the packets, the invention associates a first time code to the packet at the software layer. When the packet arrives at the wire, the invention associates a second time code to the packet. The delay associated with transmitting the packet is obtained by calculating the difference between the first and second time code. This difference time is measured over some predetermined number of packets. The invention characterizes the delay over the predetermined number of packets to produce a benchmark value of the transmit path from the software source to the wire by calculating the minimum, maximum, mean, median, and other relevant characteristics of the delay. The same process is repeated for the looped-back data so as to obtain a benchmark for the receive path (i.e., from the wire to the software source).

The present invention may be used for accurate testing and measurement of internet timing statistics, and for benchmarking of applications and network software layers running on systems with hardware timestamp capability. The invention may further be used to benchmark applications and network software layers on systems with hardware timestamp capability and extrapolating the results to systems without hardware timestamp capability.

The foregoing and other objects are achieved by the invention which in one aspect comprises a method of characterizing a propagation delay of a data element propagating from a software source to a physical medium destination. The method includes associating, in software, a first time code with the data element when the software source dispatches the data element to the physical medium destination. The method further includes associating, via a time-stamping circuit, a second time code with the data element when the data element reaches the physical medium destination. The method also includes subtracting the first time code from the second time code so as to calculate the propagation delay.

Another embodiment of the invention further includes characterizing an incoming propagation delay of an incoming data element propagating from the physical medium to the software source. This embodiment includes associating, via the time-stamping circuit, a third time code with the incoming data element when the incoming data element is taken from the physical medium destination. This embodiment further includes associating, in software, a fourth time code with the incoming data element when the software source receives the data element. This embodiment also includes subtracting the third time code from the fourth time code so as to calculate the incoming propagation delay.

Another embodiment of the invention further includes providing a time source and sampling the first time code from the time source when the software source dispatches the data element to the physical medium destination.

Another embodiment of the invention further includes providing a time source and sampling the second time code from the time source when the data element reaches the physical medium destination.

In another embodiment of the invention, the physical medium destination includes a network medium interface, the data element includes a data packet to be transmitted on the network medium, and the software source includes a software application for compiling the data packet.

In another embodiment of the invention, the software source compiles the data packet in an IP format.

Another embodiment of the invention further includes generating two or more data elements. For each data element, the method associates, in software, the first time code with the data element when the software source dispatches the data element to the physical medium destination. For each data element, the method also associates, via the time-stamping circuit, the second time code with the data element when the data element reaches the physical medium destination. For each data element, the method further subtracts the first time code from the second time code so as to calculate the propagation delay. The method generates statistical values that characterize the propagation delays for the two or more data elements.

In another embodiment of the invention, the statistical values are selected from the group consisting of a minimum propagation delay, a maximum propagation delay, a mean of the two or more propagation delays, a median of the two or more propagation delays, a variance of the two or more propagation delays, and combinations thereof.

In another embodiment of the invention, the two or more data elements include data packets.

In another embodiment of the invention, the two or more data elements include at least two data elements of different sizes.

In another embodiment of the invention, the two or more data elements include at least two data elements of different format types.

Another embodiment of the invention further includes calculating the propagation delay of the data element independent of the software source generating and dispatching the data elements.

Another embodiment of the invention further includes specifying one or more predetermined characteristics of the data element to the software source, such that the software source dispatches a predetermined data element, and characterizing the propagation delay of the predetermined data element.

In another embodiment of the invention, the one or more characteristics of the data element are selected from the group consisting of size, format, data content, and combinations thereof.

In another aspect, the invention comprises a system for characterizing a propagation delay of a data element propagating from a software source to a physical medium destination. The system includes a module of software code for associating a first time code with the data element when the software source dispatches the data element to the physical medium destination. The system further includes a time-stamping circuit for associating a second time code with the data element when the data element reaches the physical medium destination. The system also includes a difference calculator for subtracting the first time code from the second time code so as to calculate the propagation delay.

In another embodiment of the invention, the time-stamping circuit associates a third time code with the data element when the data element is taken from the physical medium destination. The module of software code associates a fourth time code with the data element when the software source receives the data element, and the difference calculator subtracts the third time code from the fourth time code so as to calculate an incoming propagation delay.

In another embodiment of the invention, the module of software code samples a time source to acquire the first time code when the software source dispatches the data element to the physical medium destination.

In another embodiment of the invention, the time-stamping circuit samples a time source to acquire the second time code when the data element reaches the physical medium destination.

In another embodiment of the invention, the physical medium destination includes a network medium interface, the data element includes a data packet to be transmitted on the network medium, and the software source includes a software application for compiling the data packet.

In another embodiment of the invention, the software source compiles the data packet in an IP format.

In another embodiment of the invention, the module of software code generates two or more data elements. For each data element, the module of software code associates a first time code with the data element when the software source dispatches the data element to the physical medium destination. For each data element, the time-stamping circuit associates a second time code with the data element when the data element reaches the physical medium destination, and the difference calculator calculates the propagation delay for each of the two or more data elements. A statistics calculator receives the propagation delays of the two or more data elements and calculates statistical values thereof.

In another embodiment of the invention, the statistical values are selected from the group consisting of a minimum propagation delay, a maximum propagation delay, a mean of the two or more propagation delays, a median of the two or more propagation delays, a variance of the two or more propagation delays, and combinations thereof.

In another embodiment of the invention, the two or more data elements include data packets.

In another embodiment of the invention, the two or more data elements include at least two data elements of different sizes.

In another embodiment of the invention, the two or more data elements include at least two data elements of different format types.

In another embodiment of the invention, the difference calculator calculates the propagation delay of the data element independent of the software source generating and dispatching the data elements.

In another embodiment of the invention, the one or more predetermined characteristics of the data element are selected from the group consisting of size, format, data content, and combinations thereof.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 illustrates how a prior art system uses a ping test to determine packet propagation delay; and,

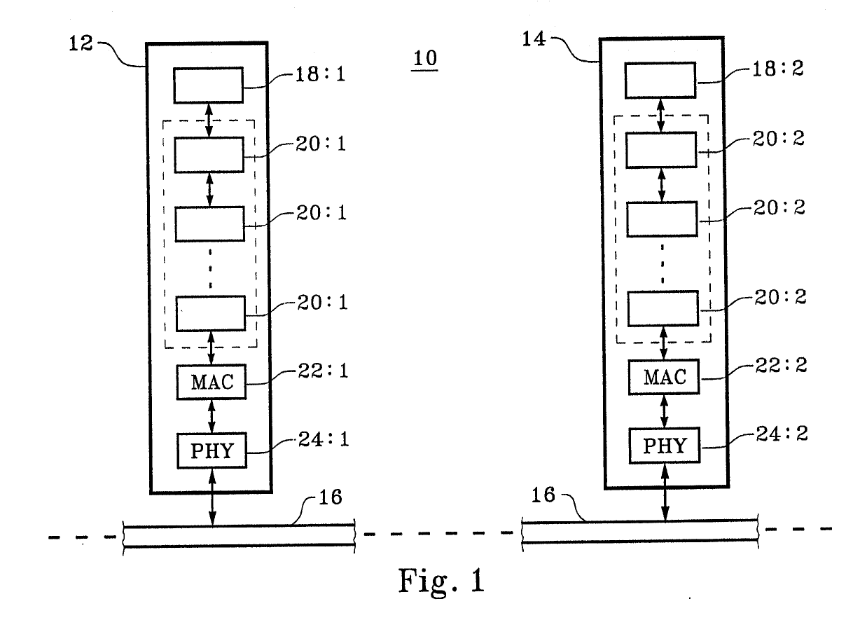

FIG. 2 shows a block diagram view of one preferred embodiment of a system for characterizing the propagation delay of a data packet from a software source to a physical network medium interface;

### DESCRIPTION OF THE PREFERRED EMBODIMENTS

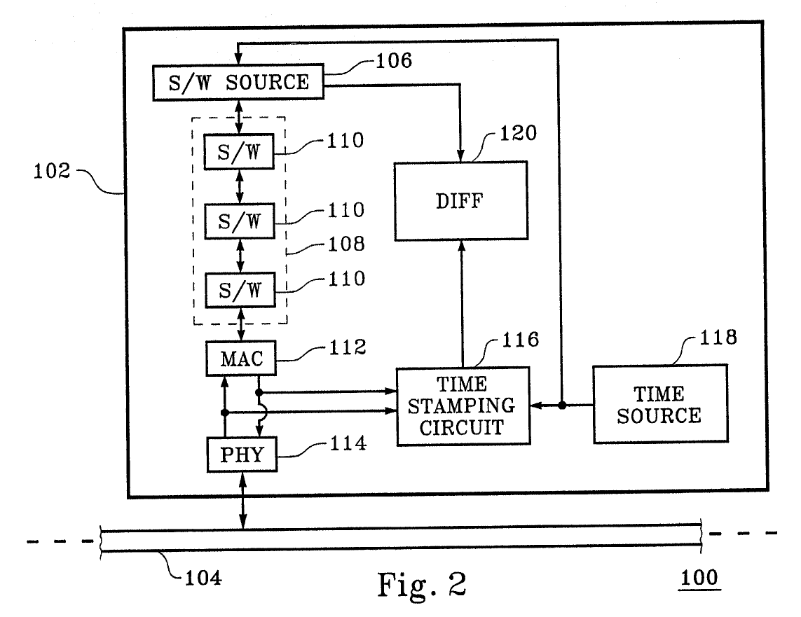

FIG. 2 shows a block diagram view of one preferred embodiment of a system 100 for characterizing a propagation delay of a data packet from a software source to a physical network medium interface. The system 100 includes a network station 102 coupled to a network medium 104. The network station includes a software source 106 that generates an outgoing data packet and dispatches the outgoing data packet to the network 104. The software source 106 may include a test application software module specifically designed for testing the network 104, or it may include a communications software module that formats data into packets to be transmitted on the network 104. The outgoing packet passes through a software stack 108 that includes one or more software layers 110. A media access controller 112 (hereinafter referred to as “MAC”) receives the outgoing packet from the software stack 108 and places the outgoing packet in a queue, in preparation for transmission on the network 104. The MAC 112 passes the queued packets to a physical media interface device 114 (hereinafter referred to as “PHY”), which provides a direct coupling to the network 104 at the physical layer. The outgoing packet may include a “live” packet that the station 102 intends to transmit to another station on the network 104. The outgoing packet may alternatively include a special test packet intended to be looped back to the software source 106 prior to being transmitted on the network 104. The PHY 114 includes circuitry for detecting special test packets and returning the test packets back to the MAC 112 instead of transmitting the test packets out to the network 104.

For the incoming transmission path, the PHY 114 receives an incoming packet from the network 104 and passes the incoming packet to the MAC 112. The MAC 112 passes the incoming packet through the software stack 108 and to the software source 106. The MAC 112 may also queue the incoming packet prior to passing it to the software stack 108.

A time-stamping circuit 116 receives outgoing packets transmitted from the MAC 112 to the PHY 114. Likewise, the time-stamping circuit 116 receives incoming packets transmitted from the PHY 114 to the MAC 112. The time-stamping circuit 116 further receives a time code from a time source 118. The time-stamping circuit 116 time-stamps the incoming and outgoing packets and passes the resulting hardware time-stamp information to a difference processor 120. In one embodiment, the difference processor 120 includes a software module running on a computer processor system, but in other embodiments the difference processor 120 may include a circuit, state machine, or other means for calculating a difference known to those in the art. The difference processor 120 also receives a software time-stamp information from the software source 106.

In one embodiment, the system 100 characterizes the propagation delay of an outgoing data packet by first associating a software time-stamp with the outgoing packet originated by the software source 106. When the software source 106 dispatches the outgoing packet to the software stack 108, the software source 106 samples the time code from the time source 118 and associates that time code with the outgoing packet. The software source 106 associating a time code with the outgoing (or incoming) packet is referred to herein as a “software time-stamp.” The software source 106 provides information regarding the software time-stamp to the difference processor 120. The packet then propagates through the software stack 108 and to the MAC 112. When the MAC 112 passes the outgoing packet to the PHY 114, the time-stamping circuit 116 (which also receives the outgoing packet) samples a time code from the time source 118 and associates that time code with the outgoing packet. The time-stamping circuit 116 associating a time code with the outgoing (or incoming) packet is referred to herein as a “hardware time-stamp.” The time-stamping circuit 116 provides information regarding the hardware time-stamp to the difference processor 120.

For incoming packets, the process is essentially the same, only in the reverse direction. The PHY 114 receives the incoming packet from the network 104 and transfers the incoming packet to the MAC 112. In the case where the software source 106 originates a special test packet, the PHY 114 loops back the special test packet, such that the looped-back test packet is treated as the incoming packet. The time-stamping circuit 116 receives the incoming packet as the packet propagates from the PHY 114 to the MAC 112, associates a time code with the packet, and transfers information regarding the hardware time-stamp to the difference processor 120. The packet passes from the MAC 112, through the software stack 120 and to the software source 106. The software source 106 associates a time code with the incoming packet and transfers the information regarding the software time-stamp to the difference processor.

Both the software time-stamp and the hardware time-stamp include information identifying the particular packet with which the time code is associated, so that the difference processor can coordinate a particular software time-stamp with the appropriate hardware time-stamp. In one embodiment, the software source 106 generates a special test packet that is identified via a unique identifier. In another embodiment, where software source 106 is generating live packets (i.e., not part of any special test), the software source 106 and the time-stamping circuitry 116 identify the packet via existing fields within the packet. Related U.S. patent application Ser. No. ______ (Attorney Docket Number BRXL-132) describes a method of identifying packets that may be used for this purpose. Other methods of identifying packets known in the art may also be used.

The difference processor 120 determines the propagation delay through the software stack 108, plus any hardware queuing delays, by calculating the absolute value of the difference between the time code in the software time stamp and the time code in the hardware time stamp. For outgoing packets, the difference processor 120 subtracts the time code of the software time-stamp from the time code of the hardware time-stamp. For incoming packets, the difference processor 120 subtracts the time code of the hardware time-stamp from the time code of the software time-stamp.

In one embodiment of the invention, the system calculates the propagation delay through the software stack 108 for two or more test packets generated by the software source 106. The difference processor 120 determines the delay for each of the outgoing test packets, so as to produce a set of outgoing delay values. The difference processor 120 also determines the delay for each of the looped-back incoming test packets, so as to produce a set of incoming delay values. The difference processor then generates a set of statistics for the outgoing delay values and a set of statistics for the incoming delay values. The statistics may comprise any statistical values known to those in the art. In one embodiment, the statistics include (but are not limited to) minimum propagation delay, maximum propagation delay, mean value of the propagation delay, variance of the propagation delays, and combinations thereof. The system 100 may generate a set of test packets of varying sizes and generate the statistics thereof. This set of test packets may be randomly varying or they may vary according to a preset pattern. Further, the system 100 may generate statistics of multiple groups of test packets, where each group includes packets of the same size, and the packet size varies form group to group. Similarly, another embodiment of the system 100 may generate the statistics of packets having varying data content, varying protocol, varying format, or combinations thereof. For example, one preferred embodiment of the invention generates statistics of Internet Protocol (IP) packets generated by the software source 106, but other protocols and formats known in the art may similarly be used.

The utility of the present invention is that it can characterize packet propagation delay through software stacks and due to hardware queuing, from a software source to a physical medium destination. Although the preferred embodiments described herein deal with data packets transmitted to and from a network, the invention may be used to characterize the propagation delay of any type of data element from a software source to a physical medium destination. For example, in a computer system a software process may generate a data character that must be displayed on a computer screen. The computer system may require a characterization of the data element propagation delay from that software process to the computer screen. The present invention may be used to characterize the propagation delay by generating a software time-tag at the software process, incorporating circuitry to generate a hardware time-tag when the character reaches the screen, and calculating the difference between the two associated time codes.

The utility of the present invention is also that it can characterize such propagation delays while the host system is operating. This is useful because similar characterization of the propagation delay through a software component independent of the target system may be inaccurate. A software component often operates differently while embedded in the system (as compared to “stand-alone” operation) due to interface and loading considerations. Further, the propagation delay measured through a software component embedded in a system may not be accurate if the system is not operating as it is intended. During actual operation, the throughput characteristics of a software component will vary as system loading and other factors vary. Since the invention allows measurement of propagation delays while the system is fully operating, a more realistic characterization of the software throughput will result.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of characterizing a propagation delay of a data element propagating from a software source to a physical medium destination, comprising:
associating, in software, a first time code with the data element when the software source dispatches the data element to the physical medium destination;
associating, via a time-stamping circuit, a second time code with the data element when the data element reaches the physical medium destination; and, subtracting the first time code from the second time code so as to calculate the propagation delay.

2. A method according to claim 1, further including characterizing an incoming propagation delay of an incoming data element propagating from the physical medium to the software source, comprising:
associating, via the time-stamping circuit, a third time code with the incoming data element when the incoming data element is taken from the physical medium destination;
associating, in software, a fourth time code with the incoming data element when the software source receives the data element; and,
subtracting the third time code from the fourth time code so as to calculate the incoming propagation delay.

3. A method according to claim 1, further including providing a time source and sampling the first time code from the time source when the software source dispatches the data element to the physical medium destination.

4. A method according to claim 1, further including providing a time source and sampling the second time code from the time source when the data element reaches the physical medium destination.

5. A method according to claim 1, wherein the physical medium destination includes a network medium interface, the data element includes a data packet to be transmitted on the network medium, and the software source includes a software application for compiling the data packet.

6. A method according to claim 5, wherein the software source compiles the data packet in an IP format.

7. A method according to claim 1, further including generating two or more data elements, and for each data element:
(i) associating, in software, the first time code with the data element when the software source dispatches the data element to the physical medium destination;
(ii) associating, via the time-stamping circuit, the second time code with the data element when the data element reaches the physical medium destination;
(iii) subtracting the first time code from the second time code so as to calculate the propagation delay;
and further generating statistical values that characterize the propagation delays for the two or more data elements.

8. A method according to claim 7, wherein the statistical values are selected from the group consisting of a minimum propagation delay, a maximum propagation delay, a mean of the two or more propagation delays, a median of the two or more propagation delays, a variance of the two or more propagation delays, and combinations thereof.

9. A method according to claim 7, wherein the two or more data elements include data packets.

10. A method according to claim 7, wherein the two or more data elements include at least two data elements of different sizes.

11. A method according to claim 7, wherein the two or more data elements include at least two data elements of different format types.

12. A method according to claim 1, further including calculating the propagation delay of the data element independent of the software source generating and dispatching the data elements.

13. A method according to claim 1, further including specifying one or more predetermined characteristics of the data element to the software source, such that the software source dispatches a predetermined data element, and characterizing the propagation delay of the predetermined data element.

14. A method according to claim 13, wherein the one or more characteristics of the data element are selected from the group consisting of size, format, data content, and combinations thereof.

15. A method of measuring a propagation delay of an IP data packet propagating from a software source to a physical network medium interface, comprising:
associating, in software, a first time code with the IP data packet when the software source dispatches the IP data packet to the physical network medium interface;
associating, via a time-stamping circuit, a second time code with the IP data packet when the IP data packet reaches the physical network medium interface; and,
subtracting the first time code from the second time code so as to calculate the propagation delay.

16. A method according to claim 15, further including characterizing an incoming propagation delay of an incoming IP data packet propagating from the physical network medium interface to the software source, comprising:
associating, via the time-stamping circuit, a third time code with the incoming data packet when the incoming data packet is taken from the physical network medium interface;
associating, in software, a fourth time code with the incoming data packet when the software source receives the data packet; and,
subtracting the third time code from the fourth time code so as to calculate the incoming propagation delay.

17. A method according to claim 15, further including providing a time source and sampling the first time code from the time source when the software source dispatches the data packet to the network medium interface.

18. A method according to claim 15, further including providing a time source and sampling the second time code from the time source when the data packet reaches network medium interface.

19. A method according to claim 15, further including generating two or more data packets, calculating the propagation delay for each of the two or more data packets, and generating statistical values that characterize the propagation delays for the two or more data packets.

20. A method according to claim 19, wherein the statistical values is selected from a group consisting of a minimum propagation delay, a maximum propagation delay, a mean of the two or more propagation delays, a median of the two or more propagation delays, a variance of the two or more propagation delays, and combinations thereof.

21. A system for characterizing a propagation delay of a data element propagating from a software source to a physical medium destination, comprising:
a module of software code for associating a first time code with the data element when the software source dispatches the data element to the physical medium destination;
a time-stamping circuit for associating a second time code with the data element when the data element reaches the physical medium destination; and,
a difference calculator for subtracting the first time code from the second time code so as to calculate the propagation delay.

22. A system according to claim 21, wherein (i) the time-stamping circuit associates a third time code with the data element when the data element is taken from the physical medium destination, (ii) the module of software code associates a fourth time code with the data element when the software source receives the data element, and (iii) the difference calculator subtracts the third time code from the fourth time code so as to calculate an incoming propagation delay.

23. A system according to claim 21, wherein the module of software code samples a time source to acquire the first time code when the software source dispatches the data element to the physical medium destination.

24. A system according to claim 21, wherein the time-stamping circuit samples a time source to acquire the second time code when the data element reaches the physical medium destination.

25. A system according to claim 21, wherein the physical medium destination includes a network medium interface, the data element includes a data packet to be transmitted on the network medium, and the software source includes a software application for compiling the data packet.

26. A system according to claim 25, wherein the software source compiles the data packet in an IP format.

27. A system according to claim 21, wherein the module of software code generates two or more data elements, and for each data element,
(i) the module of software code associates a first time code with the data element when the software source dispatches the data element to the physical medium destination;
(ii) the time-stamping circuit associates a second time code with the data element when the data element reaches the physical medium destination;
(iii) the difference calculator calculates the propagation delay for each of the two or more data elements;
wherein a statistics calculator receives the propagation delays of the two or more data elements and calculates statistical values thereof.

28. A system according to claim 27, wherein the statistical values are selected from the group consisting of a minimum propagation delay, a maximum propagation delay, a mean of the two or more propagation delays, a median of the two or more propagation delays, a variance of the two or more propagation delays, and combinations thereof.

29. A system according to claim 27, wherein the two or more data elements include data packets.

30. A system according to claim 27, wherein the two or more data elements include at least two data elements of different sizes.

31. A system according to claim 27, wherein the two or more data elements include at least two data elements of different format types.

32. A system according to claim 21, wherein the difference calculator calculates the propagation delay of the data element independent of the software source generating and dispatching the data elements.

33. A system according to claim 21, wherein the software source dispatches a data element having one or more predetermined characteristics.

34. A system according to claim 33, wherein the one or more predetermined characteristics of the data element are selected from the group consisting of size, format, data content, and combinations thereof.

35. A system for measuring a propagation delay of an IP data packet propagating from a software source to a physical network medium interface, comprising:
a module of software code for associating a first time code with the IP data packet when the software source dispatches the IP data packet to the physical network medium interface;
a time-stamping circuit for associating a second time code with the IP data packet when the IP data packet reaches the physical network medium interface; and,
a difference calculator for subtracting the first time code from the second time code so as to calculate the propagation delay.

36. A system according to claim 35, wherein (i) the time-stamping circuit associates a third time code with the data packet when the data packet is taken from the physical network medium interface, (ii) the module of software code associates a fourth time code with the data packet when the software source receives the data packet, and (iii) the difference calculator subtracts the third time code from the fourth time code so as to calculate an incoming propagation delay.

37. A system according to claim 35, wherein the module of software code samples a time source to acquire the first time code when the software source dispatches the IP data packet to the physical network medium interface.

38. A system according to claim 35, wherein the time-stamping circuit samples a time source to acquire the second time code when the IP data packet reaches the physical network medium interface.

39. A system according to claim 35, wherein the module of software code generates two or more IP data packets, and for each data packet,
(i) the module of software code associates a first time code with the data packet when the software source dispatches the data packet to the physical network medium interface;
(ii) the time-stamping circuit associates a second time code with the data packet when the data element reaches the physical network medium interface;
(iii) the difference calculator calculates the propagation delay for each of the two or more data packets;
wherein a statistics calculator receives the propagation delays of the two or more data packets and calculates statistical values thereof.

40. A system according to claim 39, wherein the statistical values include a minimum propagation delay, a maximum propagation delay, a mean of the two or more propagation delays, a median of the two or more propagation delays, a variance of the two or more propagation delays, and combinations thereof.

41. A system according to claim 39, wherein the two or more data packets include at least two data elements of different sizes.

42. A system according to claim 39, wherein the two or more data packets include at least two data packets of different format types.

43. A system according to claim 35, wherein the difference calculator calculates the propagation delay of the data packets independent of the software source generating and dispatching the data packets.

44. A system according to claim 35, wherein the software source dispatches a data packets having one or more predetermined characteristics.

45. A system according to claim 44, wherein the one or more predetermined characteristics of the data packets are selected from the group consisting of size, format, data content, and combinations thereof.
